(19) United States
(12) Patent Application Publication
(10) Pub. No.: US 2005/0129268 A1
(43) Pub. Date: Jun. 16, 2005

(54) Method and system for watermarking an electrically depicted image

(76) Inventors: Kurato Maeno, Saitama (JP); Qibin Sun, Singapore (SG); Shih-Fu Chang, New York, NY (US); Masayuki Suto, Saitama (JP)

Correspondence Address: RABIN & Berdo, PC, 1101 14TH STREET, NW, SUITE 500, WASHINGTON, DC, 20005, US

(21) Appl. No.: 10/482,073

(22) PCT Filed: Jun. 28, 2002
(86) PCT No.: PCT/US02/16599

Related U.S. Application Data
(60) Provisional application No. 60/302,184, filed on Jun. 29, 2001.

(51) Int. Cl. G06K 9/00

(52) U.S. Cl. 382/100

(57) ABSTRACT

A system for watermarking an image file selects coefficients using a selection procedure that is kept secret, and assigns the selected coefficients to coefficient pairs. The difference between the coefficients of the pairs is biased by a value that varies, preferably in a pseudo-random manner, and the biased differences are used to generate signature bits that characterize the authentic image at different locations. To detect an unauthorized alteration after the image file has been watermarked, coefficient pairs are selected using the same secret procedure that was originally used to generate the signature bits. The difference between the coefficients of the pairs is then biased and checked against the signature bits. Using a varying bias value permits a tolerance band for reducing false alarms to be used without the risk that would otherwise exist that evidence of an attack on the original image might be hidden in the tolerance band.

### BACKGROUND OF THE INVENTION

The present invention is directed to a method and a system for watermarking an electronically depicted file, particularly an image file, so that unauthorized alterations in the file can be detected.

A colored photograph of a scene such as a bowl of fruit typically contains many variations in color and shading. The apple may be predominantly red but have regions of a brownish or yellowish hue, and perhaps areas that are still green to one degree or another. The bananas are various shades of yellow and brown, with maybe some green, too, and the grapes are purple. Shadows and highlights suggest the curvature of the fruit. Despite this visual complexity, though, every spot on the photograph can be depicted by a point in a color space defined by a red axis, a green axis that is orthogonal to the red axis, and a blue axis that is orthogonal to both the red and green axes. At the origin of this RGB coordinate system, where all three colors have the value of zero, the visual impression is black. At some maximum value along the red axis, green axis, and blue axis, the visual impression is white. Between black at the origin and white at some common, maximum value along all three axes, a line can be drawn that depicts various shades of gray.

This line that depicts various shades of gray can be used to establish an axis in a new color space. This axis is called the luminance axis (generally designated by the letter Y), and it is accompanied in the new color space by a red chrominance axis (commonly designated Cr or V) and a blue chrominance axis (commonly represented by Cr or U). Just as every spot on the photograph could be represented in the RGB color space, every spot can be represented in the YCrCb color space. Simple equations for translating from the RGB color space to the YCrCb and vice versa are well known. Other color spaces are also known and used on occasion.

The human eye is much more sensitive to changes in the gray level than it is to changes in color. This means that the luminance information is more important than the chrominance information or, in other words, the apparent quality of an image falls only slowly as chrominance information is discarded. Various image encoding techniques (which also typically permit data compression) exploit this fact in order to reduce the file size of an image without a commensurate loss in the apparent quality of the image.

One such encoding technique is the original JPEG technique, introduced by the Joint Photographic Experts Group in the early 1990s. It is described in the standard ISO/IEC 10918-1. The original JPEG technique (occasionally called “JPEG-original” hereafter) will now be summarized with reference to FIGS. 1A and 1B.

In FIG. 1A, an image encoder 20 receives an input signal from an image source unit 22, such as a digital camera, a scanner, or a memory that stores the image. It will be assumed that the input signal is a digital signal with red, green, and blue components. The encoder 20 includes a color space converter 24 that converts the red, green, and blue components of the input signal to a YCrCb color space. The luminance (or Y) component is fed to a luminance branch 26. The red chrominance (or Cr) component is fed to a red chrominance branch 28, and the blue chrominance (or Cb) component is fed to a blue chrominance branch 30. The branch 26 for the luminance component includes a subdivision unit 32, a discrete cosine transform (DCT) unit 34, a quantizer 36, and an entropy encoder 38 (a Huffman encoder, which reduces the file size by assigning codes to data words, with the shorter codes being assigned to the data words that are more likely to be present and with longer codes being assigned to less likely data words).

The subdivision unit 32 divides the luminance component into blocks that are 8 pixels wide and 8 pixels high. The DCT unit 34 performs a discrete cosine transform or DCT on each of these blocks. The discrete cosine transform, which is related to the Fourier transform, results in sixty four coefficients for weighting sixty four basis functions, or basis images. The sixty four basis functions employed in the discrete cosine transform essentially represent patterns that are coextensive with the original block and that depict the frequency of changes in the horizontal direction of the block and in the vertical direction of the block. Here, “frequency” refers to the rate of variations with respect to space, not time. The portion of the original image that is represented by the 64 pixel values in the 8×8 block is equivalent to the sum of the sixty four basis functions, weighted by the coefficients generated via the discrete cosine transform.

The sixty four coefficients that are generated by DCT unit 34 for each block are placed in array, in a predetermined order, and provided to the quantizer 36. It is the quantizer 36 (along with the quantizers in the chrominance branches) that is the primary engine for data compression. The quantizer 36 employs a quantization table having sixty four quantization values, one for each of the sixty four DCT coefficients. Different quantizing tables may be selected depending upon the desired quality of the compressed image. The higher the quality, the less the compression. The quantizing values in the selected table are integers (some of which are typically the same). The quantizer 36 quantizes the DCT coefficients by dividing each coefficient by its corresponding quantizing value and then rounding down to the nearest imager, discarding any fractional results. Since the DCT coefficients for basis functions with higher frequency variations tend to be small, in practice, and also since the quantizing values for these coefficients are larger in magnitude than the quantizing values for coefficients corresponding to lower frequency basis functions, the DCT coefficients for the higher frequency basis functions are frequency quantized to 0. The elimination of fractional results during the quantization process and the likelihood that a substantial number of the quantized coefficients will turnout to be 0, in practice, means that substantial data compression is achieved by the quantizer 36. Further data compression is achieved by the encoder 38, which entropy encodes the quantized DCT coefficients and supplies them to a formatting unit 40.

The branches 28 and 30 for the chrominance components are the same, in general, as the branch 26 described above for the luminance component. The primary difference is in the quantizers. Since the human eye is less sensitive to spatial variations in color than it is to spatial variations in luminance, the quantizing tables used by the quantizers in branches 28 and 30 have quantizing values that are larger in magnitude than the quantizing values in the table employed in quantizer 36. The result is that the amount of data discarded in the chrominance branches is larger than the amount discarded in the luminance branch, without this increased loss of data degrading the apparent quality of the compressed image significantly. The quantized-and-encoded DCT coefficients in the chrominance branches, like the quantized-and-encoded DCT coefficients in the luminance branch, are supplied to the formatting unit 40.

The formatting unit 40 assembles the quantized-and-encoded coefficients into an encoded image data frame. It provides the frame with a header having various information, including information about the quantization tables employed and the encoding by the encoders 38, so that the encoded image can be reconstructed. The frame is then delivered to a utilization unit 42, such as a storage device, an interface to a transmission medium which conveys the frame to another location, or a decoder to reconstruct the image for immediate presentation on a display.

An image decoder 44 for reconstructing the image is shown in FIG. 1B. It receives the encoded image data frame from an encoded image source 46, and includes a payload extractor 48 which delivers the quantized-and-encoded coefficients for luminance to a luminance branch 50, the quantized-and-encoded coefficients for red chrominance to a red chrominance branch 52, and the quantized-and-encoded coefficients for blue chrominance to a blue chrominance branch 54. The payload extractor 48 also retrieves information about quantization and encoding from the header of the frame and supplies this information to the branches 50-54. Each of these branches basically performs operations that are the inverse of the operations performed by the corresponding branches of the image encoder 20 in FIG. 1A. For example, the luminance branch 50 includes a decoder 56 that expands the data encoded by encoder 38. The expanded data is provided to an inverse quantizer 58, which multiplies the quantized coefficients by the same quantization value by which they were divided in the quantizer 36. The results are provided to an inverse transform unit 60, which performs an inverse discrete cosine transform in order to regenerate 8×8 blocks of pixel values that approximate the original 8×8 blocks. Such blocks are assembled into a total luminance image by a subdivision assembly unit 62. The total luminance image, together with total chrominance images from the branches 52 and 54, are then supplied to a color space converter 64, which transforms the image back to RGB space. The reconstructed image can then be shown on a utilization device 66 such as a display device.

Photo editing software is available which permits image files to be manipulated in a wide variety of ways. An image may be cropped, for example, or altered by replacing a portion of the image with content taken from a different image. Other editing possibilities include increasing the compression, adjusting the colors, copying one portion of an image over a second portion in order to obliterate the second portion, and so forth. Such alterations may have a benign purpose, as when a blemish is removed from a portrait, or they may have a malicious purpose, as when the picture of an automobile accident is altered in an attempt to avoid responsibility by deception. Regardless of the purpose, alteration of an image can be characterized as an attack on the integrity of the image. It is desirable to be able to detect such an attack. An image is said to be watermarked if means are provided for detecting an attack, other than perhaps an acceptable degree of compression (which carries with it corresponding reduction in image quality), or adjustment of brightness or colors.

The springboard for the present invention is a watermarking technique described by Ching-Yung Lin and Shih-Fu Chang (who is one of the co-inventors herein) in an article entitled “Semi-Fragile Watermarking for Authenticating JPEG Visual Content,” Proc. SPIE, Security and Watermarking of Multimedia Contents, San Jose, Calif., pp. 140-151, January 2000. Here, “semi-fragile” means that the watermarking technique is sufficiently flexible to accommodate acceptable manipulation of the image, such as a modest degree of compression, but has a low tolerance for other other types of image manipulation.

In the watermarking technique described in the above-noted article by Lin and Chang, so-called “signature” bits are generated from an image and then embedded in the image. To generate the signature bits, 8×8 blocks of an image are grouped in pairs of blocks using a secret mapping function. For each block pair, predetermined DCT coefficients are selected. The signature bits are generated on the basis of the relationship between the magnitude of the selected coefficients for one block of a pair and the magnitude of the selected coefficients for the other block of the pair. More specifically, if a given coefficient for the first block of a pair is smaller than the given coefficient for the second block of the pair, a signature bit of 0 is generated; and otherwise, a signature bit of 1 is generated. This can be expressed as:
Sᵢ=1 if Fᵢ(block 1)−Fᵢ(block 2)≧0, and
Sᵢ=0 if Fᵢ(block 1)−Fᵢ(block 2)<0 Equations (1)
Here, Sᵢ is the i-th signature bit, which characterizes the relationship between the i-th DCT coefficients Fᵢ generated from block 1 and block 2 of a two-block pair.

The signature bits Sᵢ are embedded by using a secret mapping function to select to serve as hosts for the embedding. The embedding is accomplished by adjusting the least significant bits of the host coefficients in accordance with the signature bits.

This procedure for generating signature bits and selecting host coefficients in which they will be embedded will now be illustrated by an example, with reference to FIGS. 2A-2C. FIG. 2A shows an image 68 of a house and the sun in the sky above it. Using a first secret mapping function, 8-pixel by 8-pixel blocks 70, 72, and 74 are selected and are paired with 8-pixel by 8-pixel blocks 76, 78, and 80. FIG. 2B illustrates an array 70′ for receiving the sixty four DCT coefficients generated from, say, the luminance component of block 70. Summarily, FIG. 2C illustrates an array 76′ for receiving the sixty-four DCT coefficients generated from the luminance component of block 76, which is paired with block 70. Using further mapping rules, signature-source coefficients in the arrays 70′ and 76′ that are to be used for generating signature bits are selected, and host coefficients where the signature bits are to be embedded are selected as well. This is illustrated, in this example, by using circles in FIGS. 2B and 2C to designate source coefficients selected for generating signature bits. Hexagons are used to designate host coefficients selected for embedding the signature bits.

For purposes of illustration, suppose that the first signature bit S₁ for the block pair 70, 76 is to be generated from the coefficient at row number 1, column number 1 of array 70′ and the corresponding coefficient at row number 1, column number 1 of array 76′, and that this signature bit is to be embedded in the coefficient at row 6, column 5 of array 70′. Applying Equations 1, the signature bit to be embedded would be S₁=1 if the coefficient at row 1 column 1 in array 70′ is as large or larger than the coefficient at row 1, column 1 of array 76′, and S₁=0 if the coefficient at row 1, column 1 of array 70′ is smaller than the coefficient at column 1, row 1 of array 76′.

The embedding operation described in the above-noted article by Lin and Chang is conducted by replacing the DCT coefficient F_{6,5} that would normally appear at row 6, column 5 of array 70′ (that is, the host coefficient in this example) by a modified value F*_{6,5}, called a reference coefficient. It is calculated a two-step procedure from F_{6,5}, the signature bit Sᵢ (where i=1 in this example), and the quantization value Q_{6,5} by which F_{6,5} would normally be divided during the subsequent quantization procedure. In the first step, F_{6,5} and Q_{6,5} are used to calculate an intermediate value, as follows:

$${f}_{6 , 5} = IntegerRound \frac{{F}_{6 , 5}}{{Q}_{6 , 5} + 1} \qquad Equation ( 2 )$$

Here, “IntegerRound” means rounded up or down to the nearest integer. In the second step, the reference coefficient F*_{6,5} is calculated as follows:

$$\begin{matrix}{F}_{6 , 5}^{*} = {f}_{6 , 5} ( {Q}_{6 , 5} + 1 ) \\ if the LSB of {f}_{6 , 5} = {S}_{i} , \\ and \\ {F}_{6 , 5}^{*} = [ {f}_{6 , 5} + sgn ( \frac{{F}_{6 , 5}}{{Q}_{6 , 5} + 1} - {f}_{6 , 5} ) ] ( {Q}_{6 , 5} + 1 ) \\ if the LSB of {f}_{6 , 5} \neq {S}_{i}\end{matrix} \qquad Equation ( 3 )$$

Here, “sgn” is minus 1 if the expression following it is negative and plus 1 if the expression following it is not negative.

In the authentication process, signature bits are extracted from the received image and check to see whether they meet criteria set forth in the article by Lin and Chang. The article introduces two theorems, one of which basically provides that there is an invariant relationship, before and after quantization, between DCT coefficients generated from two 8×8 non-overlapping blocks of an image. The second theorem basically provides that, under certain conditions, the exact value of an unquantized coefficient can be reconstructed after quantization. In particular, the second theorem asserts that if a DCT coefficient is modified to an integral multiple of a pre-determined quantization value which is larger than all possible quantization values in subsequent JPEG compression, then this modified coefficient can be exactly reconstructed following JPEG compression by use of the same quantization value that was employed in the original modification. This theorem provides the rationale for using the reference coefficients F*. From Equations 3, it will be apparent that embedding the signature bits as described in the above-noted article by Lin and Chang results in, at worst, a rather small modification in the quantized values. The procedure permits areas where an image has been attacked to be identified, in many cases.

The Lin and Chang article noted above addresses the possibility of false alarms, and mentions the possibility of using a tolerance bound. Such false alarms may arise due to noise, particularly if the noise is accompanied by acceptable modifications such as editing to adjust brightness. The possibility of a false alarm rises to significant levels if the i-th coefficients for the blocks of a pair have close numerical values when Equations (1) are applied, since in this case the signature bit Sᵢ is determined on the basis of a small positive or negative number. A tolerance bound M can be established, during the signature-checking stage, for withholding judgment about whether an attack has been made if the absolute value of the difference between the coefficients is smaller than M, as follows:

TABLE 1

| Relationship Range | Signature Sᵢ |
|---|---|
| Fᵢ (block 1)-Fᵢ (block 2) > M | Only Sᵢ = 0 is acceptable. |
| \|Fᵢ (block 1)-Fᵢ (block 2)\| ≦ M | Don't care. |
| Fᵢ (block 1)-Fᵢ (block 2) < −M | Only Sᵢ = 1 is acceptable |

This can be illustrated with the aid of FIG. 2D. The horizontal axis represents the difference between the i-th coefficient of the two blocks of a pair when an image is encoded (that is, on the signature-generation side), and the vertical axis represents the difference as determined when the encoded image is decoded (that is, on the signature-verification side). A signature bit having a value Sᵢ=0 is generated on the signature-generation side when the difference is greater than or equal to 0 (see Equations 1), or to the right side of the vertical axis. Without the tolerance bound M, one would expect the difference between the coefficients at the verification site to be 0 or greater in the absence of an attack. What the tolerance bound M does is to provide an indeterminate band of width 2M that follows the horizontal axis in FIG. 2D.

While the tolerance bound M reduces false alarms, it also provides a “safe harbor” for attacking an image. The reason is that an attack cannot be detected if the absolute value of the difference between the quantized coefficients is less than M. If attacks which meet this constraint were impossible for even very difficult, this vulnerability could be overlooked. Unfortunately, attacks such as replacing an object from one image with an object from another image, copying a portion of the background in an image over an object to hide the object, deleting text from a white background, inserting an object, or drawing an object on a light background may well result in quantized coefficients whose difference is small.

Image encoding techniques employing discrete cosine transforms together with compression have proven themselves to be very useful, as evidenced by the widespread success of JPEG-original. Nevertheless, image encoding using other basic approaches continues to attract attention. One of these alternative approaches employs wavelet transforms to generate coefficients, instead of discrete cosine transforms. This approach has been selected for use in JPEG-2000. The specifications for JPEG-2000 have been published as ISO/IEC JTC1/SC29/WG1.

Like the discrete cosine transform, a wavelet transform is related to the well-known Fourier transform. Unlike a discrete cosine transform, however, a discrete wavelet transform analyzes an input signal with reference to compact functions that have a value of zero outside a limited range. Cosine terms, in contrast, have recurring, non-zero values outside a limited range. In the image encoding field, discrete wavelet transforms typically employ a family of orthogonal wavelengths generated by translating a so-called “mother wavelet” to different positions and by dilating (or expanding) the mother wavelet by factors of two. Various mother wavelets that can be used to generate families of orthogonal or almost-orthogonal wavelets for use in a DWT are known. Using a DWT to analyze an input signal generates coefficients which, basically, provide an index of how well the input signal correlates with the wavelets. The coefficients provide frequency information about the input signal (in view of the dilations) as well as position information (in view of the translations).

FIG. 3A illustrates an image encoder 80 which receives an RGB image from an image source unit 82. The encoder 80 includes a color space converter 84 which converts the image to a luminance (Y) component that is supplied to a luminance branch 86, a red chrorninance (Cr) component that is supplied to a red chrominance branch 88, and a blue chrominance (Cb) component that is supplied to a blue chrominance branch 90. The luminance branch 86 includes a subdivision unit 92 that separates the luminance component into sub-units known as tiles, which are supplied to a discrete wavelet transform unit 94. The DWT unit 94 generates wavelet coefficients by using digital filters, which have characteristics that are based on the wavelet family employed.

FIG. 3B schematically illustrates a conceptual implementation of the DWT unit 94. The input signal from unit 92, representing a tile of the luminance component, is supplied to a high pass filter 96, which filters in the row direction and which is followed by a down-sampler 98, which down-samples the filtered signal by two (meaning that every other sample is discarded). The filter and down-sampled signal is then supplied to a high pass filter 100, which filters in the column direction. The result is down-sampled by two by a down-sampler 102. The result is a set of the DWT coefficients in a so-called 1HH band (“1” indicating the first level of decomposition and “HH” meaning high pass filtration in both the row and column direction). The output of down-sampler 98 is also supplied to a low pass filter 104, which filters in the column direction, and the filtered output is down-sampled by two by a down-sampler 106. This provides a set of DWT coefficients for a 1HL band.

In addition to being high pass filtered in the row direction by the filter 96, the signal from unit 92 is low pass filtered in the row direction by a filter 108. The result is down-sampled by two by a down-sampler 110 and then supplied to high pass and low pass filters 112 and 114, which filter in the column direction. The output of filter 112 is down-sampled by a down-sampler 116 to provide a set of DWT coefficients for a 1LH band. The output of filter 114 is down-sampled at 118 to complete the first level of decomposition of the tile. FIG. 3C schematically illustrates the four sub-bands of DWT coefficients resulting from the first level of decomposition.

The 1LL sub-band represents low frequency information in both filtering directions at various positions. It is down-sampled by two in both directions and thus corresponds generally to a smaller-sized, lower-quality version of the image content in the original tile. The coefficient in the 1HL, 1HH, and 1LH sub-bands represent high frequency information at various positions. This high frequency information could be used at this stage to augment the low frequency information in the 1LL sub-band so as to reconstruct the image content of the original tile. However, it is quite common to continue the decomposition for one or more additional levels.

In FIG. 3B, the output of down-sampler 118 (representing the 1LL sub-band) is provided to a high pass filter 120, which filters in the row direction, and the filtered signal is down-sampled by two at 122 and then supplied to high pass and low pass filters 124 and 126, both of which filter in the column direction. The filtered results are down-sampled to provide coefficients in the 2HH and 2HL sub-bands. The output of down-sampler 118 is also low pass filtered in the row direction, down-sampled, high pass filtered in the column direction, and down-sampled to provide coefficients in a 2LH sub-band. This process of repeatedly filtering and down-sampling the low pass residue can continue. FIG. 3D illustrates sub-bands of coefficients for the second and third levels of decomposition in the region where the 1LL sub-band (see FIG. 3C) would have been had only one level of decomposition been employed.

Returning now to FIG. 3A, DWT coefficients from unit 94 are arranged in an array and quantized by quantizer 128 in accordance with quantizing values in a quantization table, the table that is selected (that is, the magnitudes of the quantizing values) depending upon the desired degree of compression in conjunction with the amount of image deterioration that can be tolerated to achieve this compression. As was the case with the DCT transform, the values in the selected table are integers which vary in magnitude depending upon the visual significance of the particular coefficients which they are to quantize. A DWT coefficient is quantized by dividing it by its quantization value from the table (some of the quantization values in the table may be numerically the same despite the fact that they are applied to different coefficients) and any remainder is discarded.

With continuing reference to FIG. 3A, quantized DWT coefficients are supplied to an entropy encoder 130 and then to a formatting unit 132, which also receives quantized-and-encoded DWT coefficients for the red and blue chrominance components from branches 88 and 90. The formatting unit 132 places the quantized-and-encoded coefficients in an encoded image data frame along with various other information, including information for use in regenerating the encoded image. The frame is then supplied to an encoding image utilization unit 134 such as a storage device, a decoder, or a signal transmission unit for conveying the encoded image data frame to some desired destination.

An image decoder 136 is illustrated in FIG. 3E. It receives an encoded image data frame from a source 138. A payload extractor 140 retrieves the information for decoding the image and supplies the quantized and entropy-encoded coefficients for the luminance component to a luminance branch 142. The quantized and entropy-encoded coefficients for red and blue chrominance are supplied to chrominance branches 144 and 146. In luminance branch 142, a decoder 148 expands the entropy-encoded data so as to supply the quantized coefficients for the tiles of the luminance component to an inverse quantizer 150, which multiplies the quantized coefficients by values in a table. These values match the values by which the coefficients were divided during the quantizing procedure employed by the image encoder 80. After an inverse DWT transform by a unit 152, which regenerates pixel values for the tiles of the luminance component from the DWT coefficients, the tiles are combined into a total luminance image by a subdivision assembly unit 154. Pixel values for the combined tiles of the luminance and chrominance components are converted back to RGB space by a converter 156 and then supplied to a utilization device 158 such as a display apparatus.

### SUMMARY OF THE INVENTION

An object to the present invention is to provide a watermarking method and system that has a small error rate but that lacks the vulnerability to attack that has been needed to achieve a small error rate in the prior art.

Another object of the invention is to provide a watermarking method and system in which a tolerance band for reducing false alarms is effectively moved around, in a plane having one dimension defined by features extracted from a first file (such as a first image file) and having another dimension defined by features extracted from a second file (such as a second image file, which is to be checked for authenticity with respect to the first file), so as to expose evidence of an attack that might otherwise be hidden in the tolerance band. A related object is to move the tolerance band to different positions in this plane in a pseudo-random manner.

These and other objects that will become apparent during the ensuing detailed description can be attained, in accordance with one aspect of the invention, by providing a method in which groups (such as pairs) of coefficients in a first file are selected using a predetermined selection rule; first calculated values are determined from the coefficients in each group using a predetermined calculation formula (such as subtracting one coefficient in a pair from the other coefficient in the pair); the first calculated values are combined with bias values to generate biased calculated values; the biased calculated values are compared to a predetermined number (such as zero) to calculate signature values for the first file; and the signature values are then preserved, so that they can subsequently be used for determining whether a second file is an authentic version of the first file.

In accordance with another aspect of the invention, a method is provided in which groups of coefficients in a first file are selected using a predetermined selection rule; first calculated values are determined from the coefficients in each group using a predetermined calculation formula; the first calculated values are combined with bias values to generate first biased calculated values; the first biased calculated values are compared to a predetermined number to generate signature values for the first file; groups of coefficients in the second file are selected using the same predetermined selection rule that was employed for the first file; second calculated values are determined from the coefficients in each group of the second file using the same calculation formula that was employed for the first file; the second calculated values are combined with bias values (the same bias values that were employed with the first file) to generate second biased calculated values; and the second biased calculated values are compared with the signature values.

### BRIEF DESCRIPTION OF THE DRAWINGS

FIG. 1A is a schematic block diagram illustrating a conventional image encoder using discrete cosine transforms;

FIG. 1B is a schematic block diagram of a conventional image decoder for regenerating the images encoded by the arrangement of FIG. 1A;

FIG. 2A illustrates an example of the selection of pairs of blocks in accordance with a prior art technique;

FIGS. 2B and 2C illustrate arrays of DCT coefficients in pairs of blocks, with an example of coefficients that are used to generate signature bits and coefficients in which the signature bids are to be embedded in accordance with the prior art technique being marked by circles and hexagons;

FIG. 2D is a graph illustrating a tolerance bound to reduce false alarms;

FIG. 3A is a schematic block diagram illustrating a conventional image encoder using discrete wavelet transforms;

FIG. 3B is a schematic block diagram illustrating a conventional filter and down-sampling arrangement for generating wavelet coefficients;

FIGS. 3C and 3D are diagrams illustrating decomposition of an image into sub-bands of wavelet coefficients;

FIG. 3E is a schematic block diagram illustrating a conventional image decoder for regenerating an image encoded by the arrangement shown in FIG. 3A;

FIG. 4A is a schematic block diagram illustrating an image encoder in an accordance with a first embodiment of the present invention;

FIG. 4B is a schematic block diagram of a watermarking unit employed in FIG. 4A;

FIG. 4C illustrates an example of selection of pairs of blocks;

FIG. 4D is a schematic block diagram illustrating an image decoder in accordance with the first embodiment of the present invention;

FIG. 4E is a schematic block diagram of a signature verifying unit employed in the image decoder of FIG. 4D;

FIGS. 4F-4H are graphs showing the effect of a varying bias value;

FIG. 5A is a schematic block diagram of an image encoder in accordance with a second embodiment of the invention;

FIG. 5B illustrates sub-bands in three levels of decomposition of an image using a discrete wavelet transform, and shows an example of a technique for grouping coefficients in a sub-band into pairs;

FIG. 5C is a schematic block diagram illustrating a watermarking unit in the image encoder of FIG. 5A;

FIG. 5D illustrates a matrix of random values selected from a set of seven values; and

FIG. 5E is a schematic block diagram illustrating an image decoder for decoding an image that has been encoded by the image encoder of FIG. 5A.

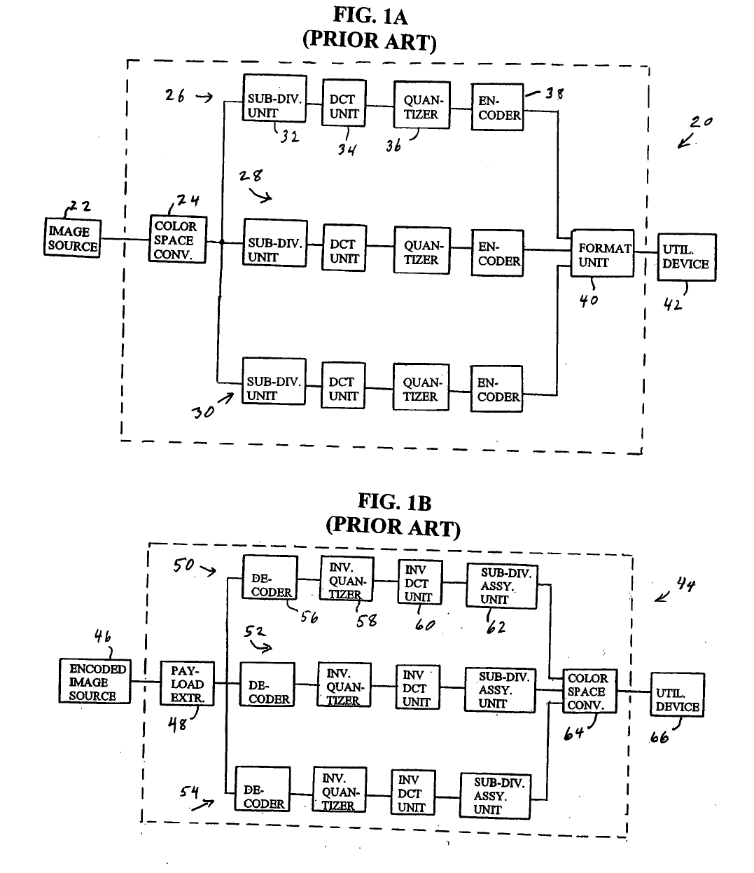

### DESCRIPTION OF THE PREFERRED EMBODIMENTS

### First Embodiment

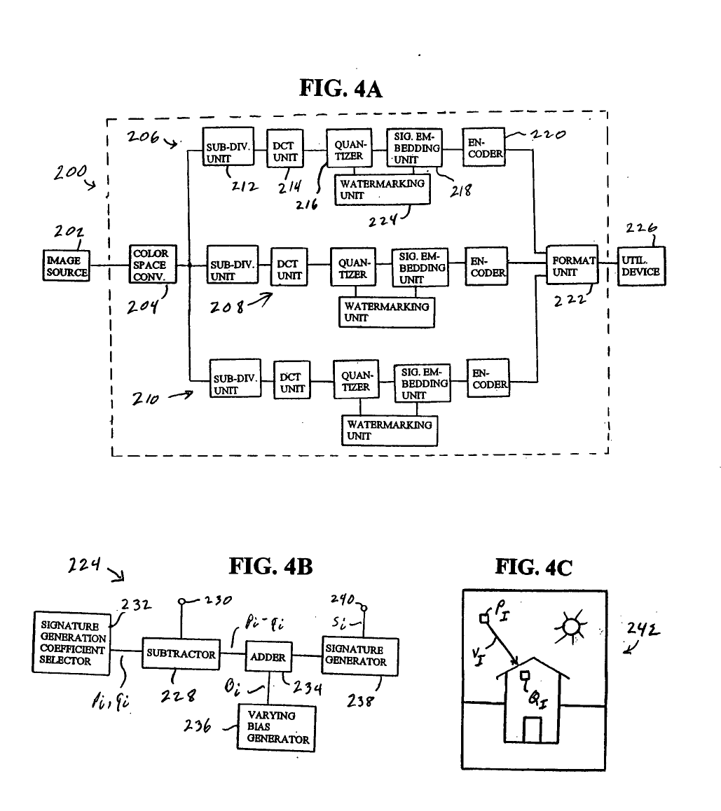

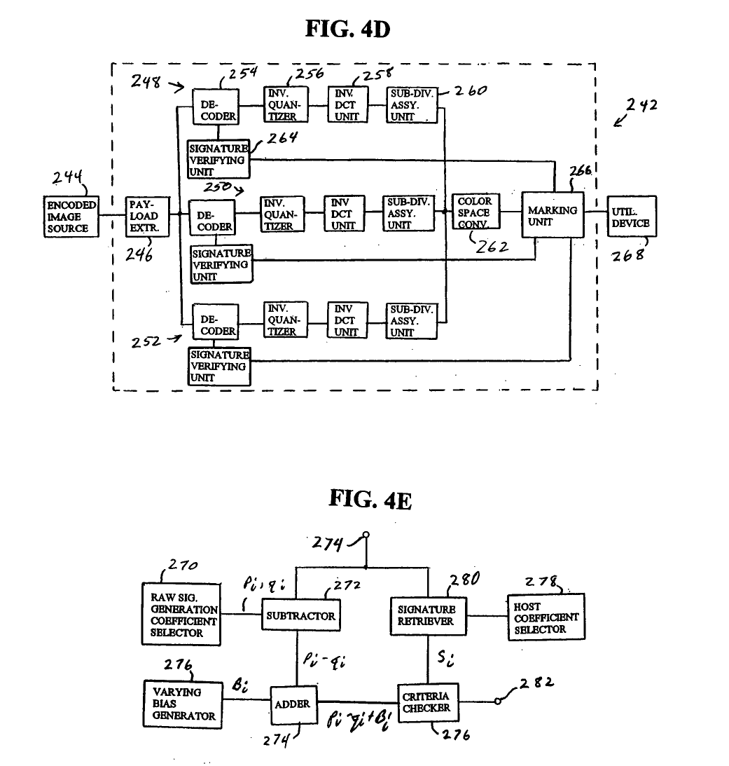

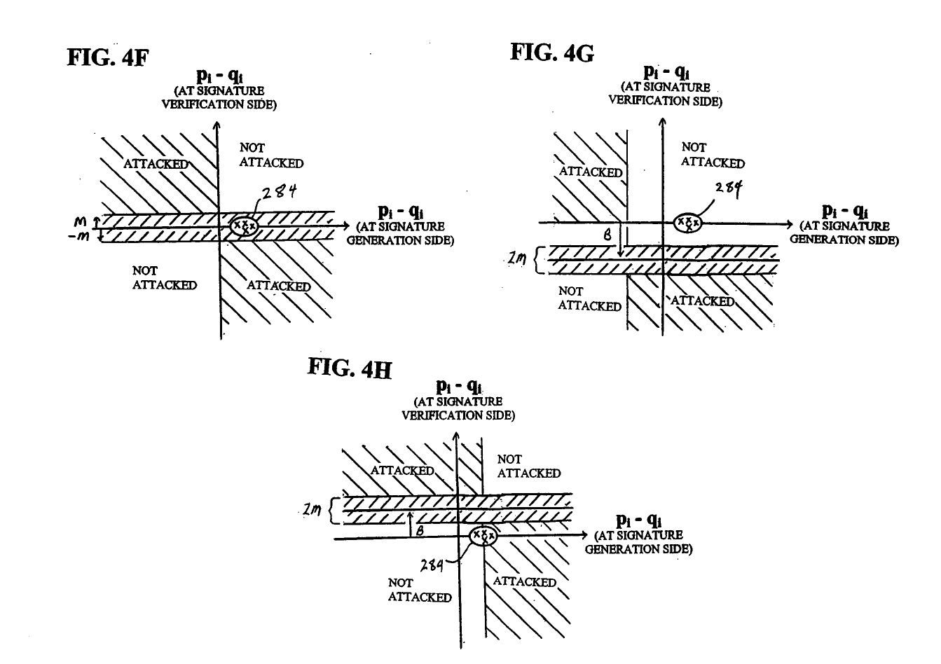

FIG. 4A illustrates an image encoder 200 in an imaging encoding system according to a first embodiment of the present intention. The encoder 200 receives a signal representing an RBG image from an image source 202, such as a digital camera, scanner, or storage device. The RGB color space is converted to a YCbCr color space by a color space converter 204. The color space converter 204 delivers the luminance (Y) component of the image to a luminance branch 206. Similarly, the red and blue chrominance components Cr and Cb are supplied to a red chrominance branch 208 and a blue chrominance branch 210.

The luminance branch 206 includes a subdivision unit 212 that subdivides the luminance component of the image into blocks of eight-pixels by eight-pixels. These blocks are supplied to a discrete cosine transform (DCT) unit 214 that performs a discrete cosine transform on the pixel values of each block in order to generate sixty four DCT coefficients for each block The sixty four coefficients for each block are grouped into an array and quantized by a quantizer 216 in accordance with a quantization table that is selected on the basis of the apparent image quality that is desired. The quantized coefficients are received by a signal embedding unit 218, the purpose of which will be discussed later, and are then encoded by an entropy encoder 220. The quantized-and-encoded coefficients for each block of the luminance component are delivered to a formatting unit 222.

The quantizer 216 is connected to a watermarking unit 224, which generates a set of signature bits Sᵢ (to be discussed later) from the quantized coefficients. The signature bits Sᵢ are supplied to the signal embedding unit 218.

The chrominance branches 208 and 210 are similar, but their quantizers use quantization tables having larger quantization values than the quantization table used in the luminance branch 206.

The formatting unit 222 forms an encoded image data frame from the quantized-and-encoded coefficients produced by the branches 206-210, and adds information in the header of the frame for use in reconstructing the image (e.g., information identifying the quantization tables, and identifying the encoding employed by the encoder 218 and the un-numbered encoders in the chrominance branches). The completed image data frame is delivered to an encoded image utilization device 226 (such as a data storage device, a means for transmitting the encoded image data frame to another location, or an image decoder which regenerates the image for a display device).

FIG. 4B illustrates the watermarking unit 224. It includes a subtractor 228 that receives the arrays of DCT coefficients for all of the blocks of the luminance component from the quantizer 216 via an input port 230. The subtractor 228 is also connected to a signature-generation coefficients selector 232, which identifies coefficient pairs pᵢ and qᵢ to the subtractor 228. These coefficient pairs are selected in accordance with a rule that is kept secret. The subtractor 228 subtracts the value of the coefficient qᵢ from the value of the coefficient pᵢ and supplies an i-th difference value (pᵢ−qᵢ) resulting from the subtraction to an adder 234. The adder 234 also receives a bias value Bᵢ from a varying bias generator 236, which receives a signal (not illustrated) indicating the current value of the index and “i” from the selector 232. The adder 234 biases the difference value pᵢ−qᵢ by adding the bias value Bᵢ to it, and supplies the biased difference value to a signature generator 238. The signature generator 238 determines the signature bits Sᵢ in accordance with the following:
Sᵢ=0 if (pᵢ−qᵢ+Bᵢ)≧0 and
Sᵢ=1 if (pᵢ−qᵢ+Bᵢ)<0 Equations (4)
The signature bits Sᵢ are supplied to the signature embedding unit 218 via an output port 240. The embedder 218 selectively alters the least significant bits of host coefficients as taught by the article by Lin and Chang that is discussed in the “Background of the Invention” section of this document. The host coefficients are chosen in accordance with a selection procedure that is kept secret.

As its name suggests, the varying bias generator 236 generates bias of values Bᵢ that very magnitude. Preferably, they vary in magnitude in a pseudo-random manner, and within a limited range. In the present embodiment, the bias values Bᵢ are integers that range from −16 to +16. Such bias values Bᵢ can be generated, for example, by multiplying a predetermined angle (say, pi/10) by the i-th term in a pseudo-random sequence, taking the sine of the product, multiplying by 16, and rounding to the nearest integer.

One possibility for a rule that can be employed by the selector 232 in order to identify coefficient pairs pᵢ, qᵢ will now be discussed with reference to FIG. 4C. This Figure illustrates an image 242 of a house and the sun shining on the house. Starting blocks P₁, P₂, . . . P₁, . . . P_{N} are selected, preferably at various locations outward from the central region of the image, in accordance with a predetermined selection list. A random number generator is then employed to generate x and y values that define vectors V₁, V₂, . . . , V₁, . . . V_{N}. Vector addition of the starting blocks P₁ and the random vectors V₁ then yields target blocks Q₁ that are paired with the starting blocks P₁. It is then necessary to employ some procedure for selecting a particular one of the sixty four DCT coefficient values generated from the pixels in the pair of blocks. One way to do this is to use i mod 64 as a selection criterion. That is, for blocks P₁ and Q₁, the first of the sixty four coefficients would be selected as the coefficients p₁ and q₁; for blocks P₂ and Q₂, the second of the sixty four coefficients would be selected as P₂ and q₂; and so on to blocks P₆₄ and Q₆₄, where the 64th coefficient would be selected from both blocks as p₆₄ and q₆₄. The next coefficient pair, P₆₅ and q₆₅, would start again with the first DCT coefficients generated for the blocks P₆₅ and Q₆₅. It should be noted that more than one pair of coefficients can be selected within the same pair of blocks by selecting the same block Pᵢ and the same vector Vᵢ more than once.

Turning now the FIG. 4D, an image decoder 242 for use with the encoder 200 of FIG. 4A will now be described. The decoder 242 receives an encoded image data frame from an encoded image source 244. A payload extractor 246 retrieves the encoded-and-quantized coefficients for the three components from the encoded image data frame, and supplies them respectively to a luminance branch (Y) 248, a red chrominance branch (Cr) 250, and a blue chrominance branch (Cb) 252. The information in the header of the image data frame that is needed for decoding the components (e.g., information identifying the quantization tables employed and the entropy encoding) is also distributed to the branches 248, 250, and 252.

The branch 248 includes a decoder 254 for expanding the entropy-encoded values, an inverse quantizer 256, an inverse DCT unit 258, and a subdivision assembly unit 260, which combines the blocks of the luminance component into a total luminance image. The chrominance branches 244 and 246 are similar. A color space converter 262 receives the total luminance image and the total chrominance images and converts them to the RGB color space.

A signature verifying unit 264 receives the quantized coefficients from decoder 254 and checks whether the signature bits Sᵢ are consistent with the coefficients pᵢ and qᵢ as determined on the signature-verifying side (that is, the image decoder 242) to generate the signature bits. If not, the unit 264 emits a signal identifying blocks with discrepancies to a marking unit 266. The marking unit 266 then superimposes markings, on the video image from converter 262, to identify regions that have been attacked. The video image with superimposed markings (if any) are then supplied to a utilization device 268, which issue usually a display device but may be an image storage device or a means for transferring the image to another location.

The construction of the signature verifying unit 264 is shown in FIG. 4E. A signature generation coefficients selector 270 selects coefficient pairs using the same secret selection procedure that was employed by the image encoder 200. The coefficient pairs pᵢ, qᵢ are identified to a subtractor 272, which receives the coefficients themselves from the decoder 254 via a port 274. A subtractor 272 finds the difference pᵢ−qᵢ between the coefficients identified by selector 270 and supplies this difference to an adder 274. A varying bias generator 276 generates the same bias values Bᵢ that were generated by the generator 236 (see FIG. 4B) and supplies this sequence of values to the adder 274, which supplies the biased difference (that is, pᵢ−qᵢ+Bᵢ) to a criteria checker 276.

A host coefficients selector 278 identifies host coefficients to a signature retriever 280, which also receives the coefficients themselves via a port 275. The selector 278 selects the host coefficients using the same secret selection procedure that was employed by the signal embedding unit 218 on the signature-generation side. The retriever 280 regenerates the signature bits Sᵢ from the coefficients identified by selector 278, preferably using the regeneration technique outlined in the above-noted article by Lin and Chang. The signature bits are supplied to a criteria checker 276, which checks the biased difference values against the signature bids in accordance with Table 2:

TABLE 2
Criteria for checking signatures Sᵢ
(“M” is a margin value for reducing false alarms
due to loss compression, noise, or variations in
the accuracy of the transforms.)

| | | |
|---|---|---|
| (pᵢ − qᵢ + Bᵢ) > M | Sᵢ = 0 | Acceptable |
| (pᵢ − qᵢ + Bᵢ) > M | Sᵢ = 1 | Not acceptable |
| \|(pᵢ − qᵢ + Bᵢ) \| ≦ M | Sᵢ = 0 or 1 | Acceptable |
| (pᵢ − qᵢ + Bᵢ) < −M | Sᵢ = 0 | Not acceptable |
| (pᵢ − qᵢ + Bᵢ) < −M | Sᵢ = 1 | Acceptable |

If any of the biased difference values pᵢ−qᵢ+Bᵢ are not acceptable in light of the signature bit Sᵢ, a discrepancies signal is supplied to the marking unit 266 (FIG. 4C) via a port 282.

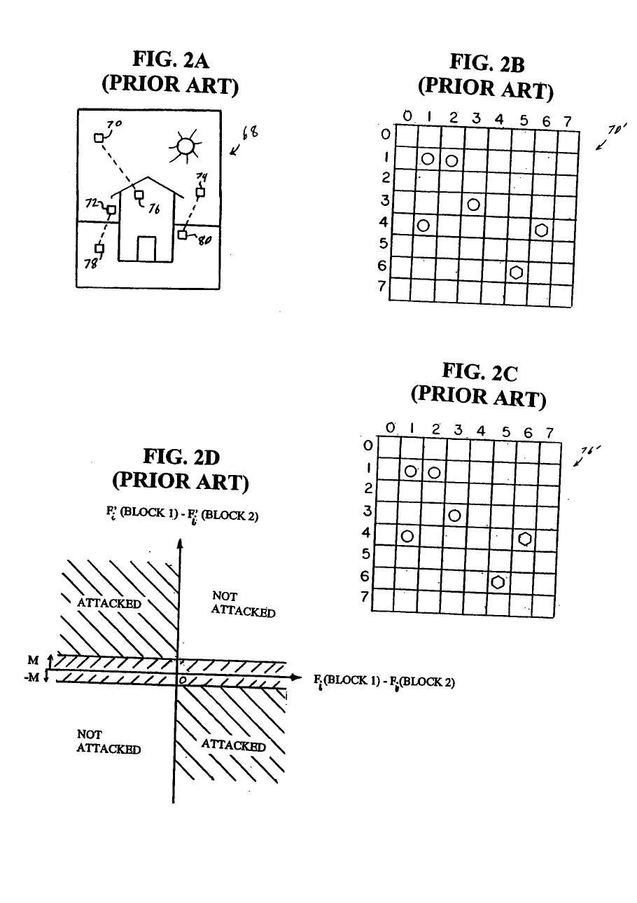

The significance of Table 2 will now be explored further with reference to FIGS. 4F-4H. FIG. 4F is similar to FIG. 2D in that the horizontal axis represents the difference between quantized coefficient pairs when an image is originally encoded (that is, on the signature-generation side) and the vertical axis represents the difference between the quantized coefficient pairs when the encoded image is regenerated (that is, on the signature-verification side). The symbols employed label the axes in FIG. 4F diverges from the symbols employed to label the axes and FIG. 2D, but the physical meaning is the same. Unlike FIG. 2D, however, FIG. 4F shows a group 284 of points, several of which are marked by Xs in the drawing, signaling an attack because the difference between coefficient pairs on the signature-generation side is significantly different from the difference between the same pairs of coefficients on the signature-verification side. However, in FIG. 4F this attack cannot be detected because the group 284 lies within the 2M tolerance band that is provided in order to reduce false alarms stemming from noise and minor (acceptable) image manipulation, such as loss compression. In the situation shown in FIG. 4E, the biased value Bᵢ is 0.

In FIG. 4G, the bias value Bᵢ has changed to a negative number, but the attack is still not detectable because the points in the group 284 are consistent with the corresponding signature values Sᵢ and consequently be group 284 does not lie in a zone where an attack can be detected. The bias value Bᵢ has changed again in FIG. 4H, and this time the group 284 of points is located partially in a zone where an attack can be detected. As the value of the index “i” changes, some of points in the group 284 will be available to signal an attack and others of the points in the group will not. However, it has been found that, in case of an attack, points defined by the difference between coefficient pairs on the signature-generation side and the difference between the same coefficient pairs on the signature-generation side tend to lie in clusters or groups in actual practice. As a result, some of the points in a group resulting from an attack will generally tend to move into an attack-detectable zone when the 2M tolerance band is moved to various locations by a way of the variable bias value Bᵢ. The tolerance band still serves its purpose of reducing false alarms, but moving it to different locations with the aid of the variable bias value Bᵢ makes it difficult for malefactor to hide an attack within the tolerance band.

The second embodiment:

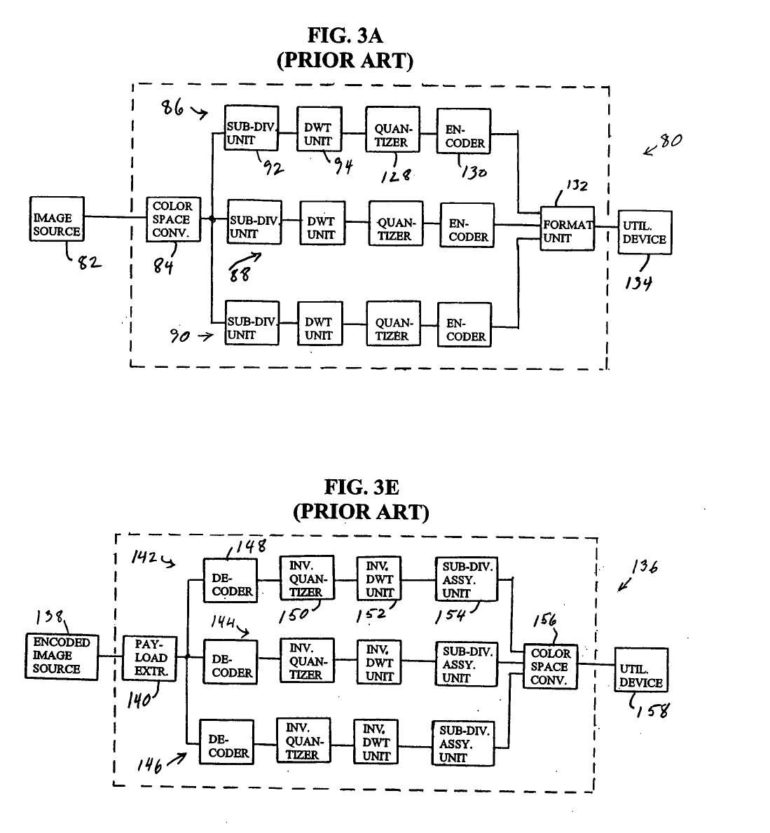

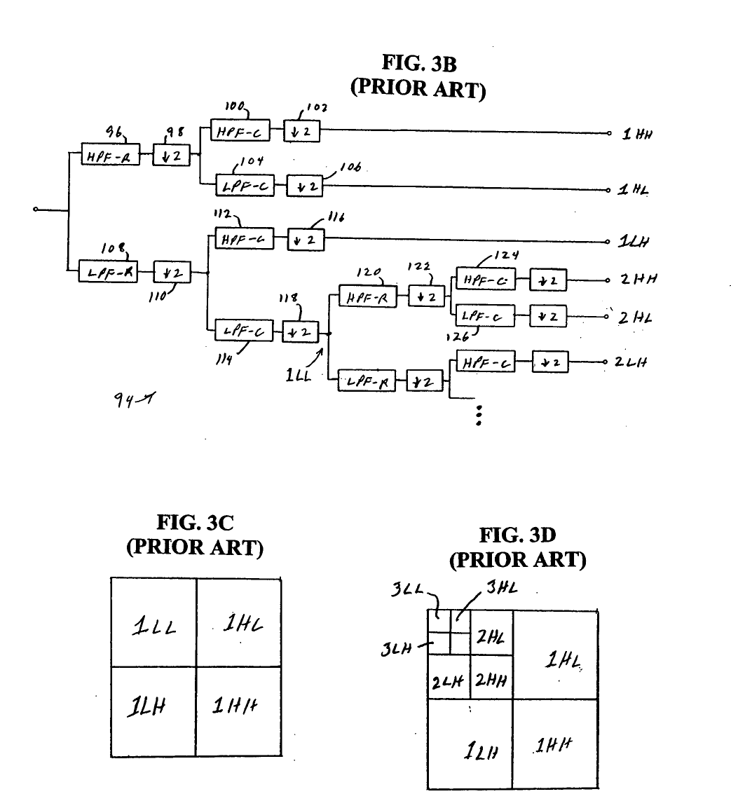

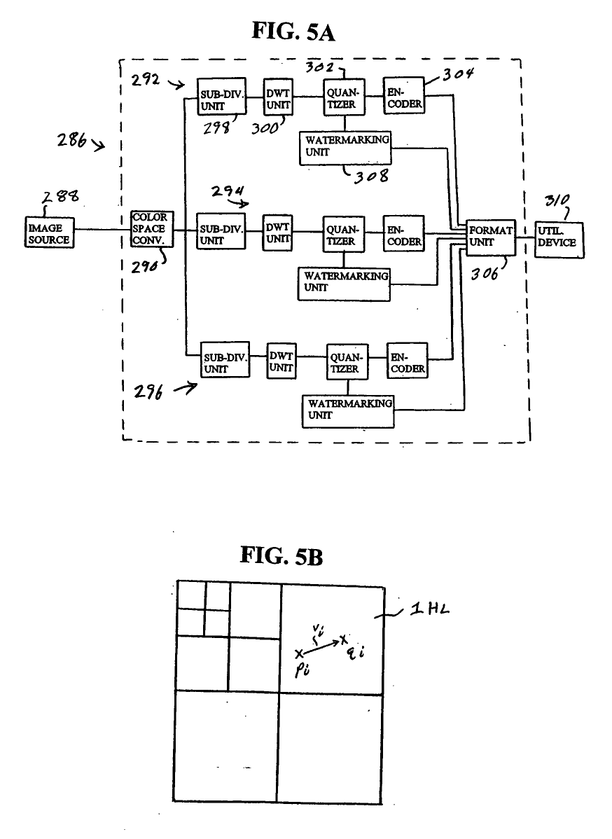

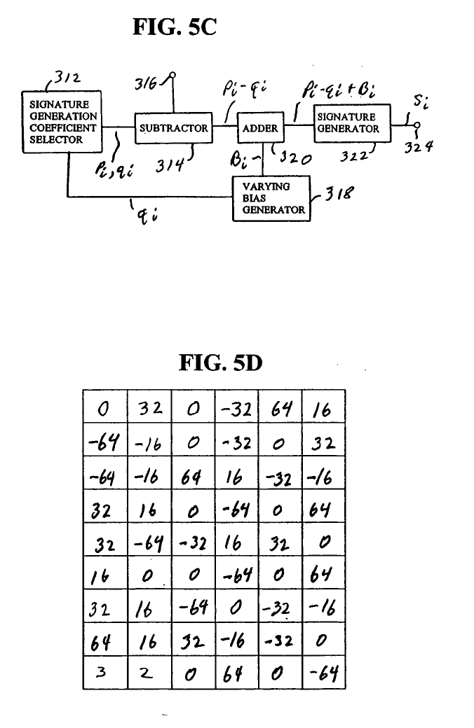

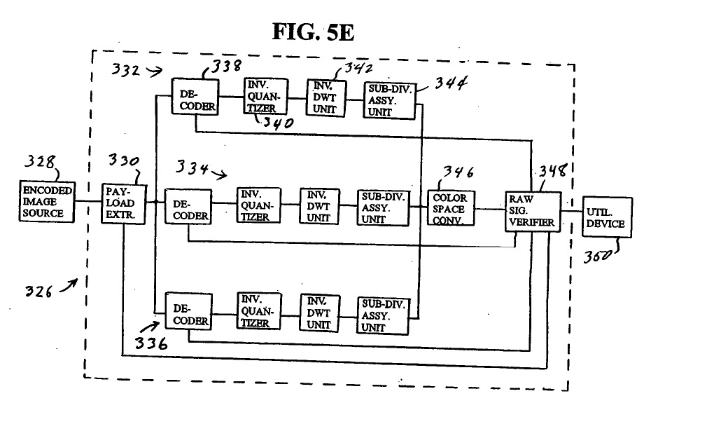

A second embodiment will now be described with reference to FIGS. 5A to 5E. FIG. 5A illustrates an image encoder 286 that receives an RGB image from a source unit 288. The encoder 286 includes a converter 290 that transforms the RGB image to a YCrCb image. The luminance component is supplied to a luminance branch 292, and the red and blue chrominance components (Cr and Cb) are delivered to chrominance branches 294 and 296. The luminance branch 292 includes a subdivision unit 298 that subdivides the luminance component provides tiles of the component to a discrete wavelet transform or DWT unit 300. The unit 300 performs horizontal and vertical filtration, with down-sampling, using digital filters configured to generate wavelet coefficients as previously discussed with reference to FIGS. 3A through 3E. For purposes of illustration it will be assumed that the unit 300 executes three levels of decomposition on each tile of the luminance component, and for each tile delivers wavelet coefficients for the sub-bands resulting from this three-level decomposition to a quantizer 302.

The quantizer 302 quantizes the coefficients in accordance with quantization values in a table, and supplies the quantized coefficients to an encoder 304, which entropy-encodes the coefficients for each tile of the luminance component and supplies them to a formatting unit 306. The quantizer 302 also supplies the wavelet coefficients to a watermarking unit 318. It identifies coefficients p₁, p₂, . . . , pᵢ, . . . , pₙ in a given sub-band using a predetermined selection rule, generates a set of vectors v₁, v₂, . . . , vᵢ, . . . , vₙ using a random number generator, and pairs each of the coefficients pᵢ with a coefficient qᵢ by adding the vectors to the locations associated with the coefficients pᵢ, . . . , pₙ. An example is shown in FIG. 5B, where a coefficient pᵢ is paired with a coefficient qᵢ in the same sub-band (the 1HL sub-band in the drawing). Coefficients in one or more additional sub-bands may be paired in the same way. It should be noted that the pairing is on a sub-band by sub-band basis; coefficients are not paired with coefficients in different sub-bands.

After the watermarking unit 308 pairs the coefficients, it generates difference values pᵢ−qᵢ by subtracting each coefficient qᵢ from its paired coefficient pᵢ, adds a pseudo-random bias value Bᵢ to the difference, and supplies a signature values Sᵢ to the formatting unit 306. Information identifying the sub-band from which each signature value originated is also supplied to the formatting unit 306.

The chrominance branches 294 and 296 are similar, the main difference being that the quantizers in these branches employ quantization tables that, in general, result in larger quantization steps than in the luminance branch 302. The quantized-and-encoded coefficients, relevant information about the image (such as a file name) and about the encoder 286 (such as information identifying the quantization tables employed and entropy encoder tables), and the signature bits Sᵢ are formatted into an encoded image data frame by the unit 306 and then delivered to an encoded image utilization device 310 (e.g., a storage device for the encoded image data frame, means for transferring it to another location, or an image decoder for restoring the image in preparation for displaying it on display device). Instead of being embedded in host coefficients, as in the first embodiment, the signature bits Sᵢ are placed in the header of the encoded image data frame by the formatting unit 306 in the present embodiment.

FIG. 5C illustrates the construction of the watermarking unit 308. A signature generation coefficient selector 312 identifies coefficient pairs pᵢ, qᵢ to a subtractor 314, which receives the coefficients themselves from the quantizer 302 via a port 316. The selector 312 also identifies the second coefficient of each pair, qᵢ, to a varying bias generator 318. The subtractor 314 calculates the difference pᵢ−qᵢ between the coefficients of the pair and supplies this difference to an adder 320, which also receives a bias value Bᵢ from the generator 318. The adder calculates a biased difference value pᵢ−qᵢ+Bᵢ from its inputs and supplies this biased difference value to a signature generator 322. The generator 322 determines a signature bit Sᵢ in accordance with Table 2 and supplies the signature bit to the formatting unit 306 by way of a port 324.

If the subdivision unit 298 (FIG. 5A) subdivides the luminance component into tiles that are 13 samples wide and 17 samples high, a so-called 9-7 irreversible wavelet transform will result in a nine-row, six-column matrix of coefficients in the 1HL sub-band for the tile. Similarly, other sub-bands will have matrices of coefficients, but the number of rows and columns in these matrices depend upon the particular sub-band. In the present embodiment, the varying bias generator 318 assigns pseudo-random numbers to positions in pseudo-random number matrices that correspond to the coefficient matrices and selects, as the bias value Bᵢ, the pseudo-random number having the same position in the relevant pseudo-random number matrix as the coefficient qᵢ has in the coefficient matrix.

An example is shown in FIG. 5D, which shows a nine-row, six-column pseudo-random number matrix of numbers selected from the set {−64, −32, −16, 0, 16, 32, 64} and randomly assigned to positions in the matrix. The matrix shown in FIG. 5D has the same dimensions (that is, number of rows and columns) as the matrix of coefficients for a tile in the 1HL sub-band. Consequently, any location in the matrix of coefficients where the coefficient qᵢ is located will correspond to a position in the pseudo-random number matrix shown in FIG. 5D. The number at the corresponding position in the pseudo-random number matrix is selected by the generator 318 as the bias value Bᵢ. The net effect is that, when the pseudo-random vector vᵢ is added to a coefficient pᵢ to determine the paired coefficient qᵢ, the pseudo-random vector vᵢ also selects the bias value Bᵢ at the same time.

It is convenient, although not necessary, to use the same matrix of random numbers for all the tiles of a component (that is, luminance, red chrominance, or blue chrominance) in a given sub-band.

An image decoder 326 for decoding the image that was encoded by the image encoder 286 is shown in FIG. 5E. The encoded data image frame is supplied to the decoder 326 by a source (e.g., a storage device) 328. A payload extractor 330 supplies the quantized-and-encoded coefficients, together with information about the quantization and entropy encoding that was used to generate them, to a luminance branch 332 and to chrominance branches 334 and 336. The luminance branch includes a decoder 338 (which expands the entropy-encoded data), an inverse quantizer 340 (which multiplies the wavelet coefficients by the same quantization values that served as divisors when the original coefficients were quantized in the image encoder 286), an inverse DWT unit 342 (which generates pixel values for the tiles of the luminance component from the wavelet coefficients), and a subdivision assembly unit 344 (which stitches the tiles of the luminance component together into a total luminance image). The chrominance branches 334 and 336 are similar. The total luminance and chrominance images are supplied to a color space converter 346, which converts the YCrCb components to an RGB image.

The decoded but still-quantized wavelet coefficients from decoder 338 in the luminance branch to 332 and similar decoders in the chrominance branches are supplied to a signature verifier 348. The signature values Sᵢ (for each of the sub-bands that was used on the signature-generation side to generate them), information identifying the coefficients pᵢ that were chosen in each of the sub-bands that were used, and information about the pseudo-random numbers characterizing the vectors vᵢ, are also retrieved from the header of the encoded image data frame by the payload extractor 330 and supplied to the signature verifier 348. The signature verifier 348 then computes difference values pᵢ−qᵢ in the restored image, adds the random bias Bᵢ (which is determined using the same matrix of pseudo-random numbers, for each sub-band of interest, that was employed by the image encoder 286), and compares the biased difference values with a signature bits Sᵢ in accordance with Table 2 to determine whether the coefficient differences in the reconstructed image are acceptable. If not, the signature verifier 348 marks areas that are judged to have been attacked when the restored image is displayed on a device 350.

Variations:

It will be apparent to those killed in the art that the specific embodiments described above are susceptible to many variations and modifications, and it is therefore the intention that such variations and modifications shall fall within the meaning and range of equivalents of the appended claims. Some of these variations and modifications will be briefly noted below.

Although the relationship between pairs of coefficients has been characterized herein by using the difference pᵢ−qᵢ, the relation can be characterized in different ways. One possibility would be to use the average, ½(pᵢ+qᵢ). Numerous other possibilities, such as the average minus the difference or the difference plus a predetermined number, also exist.

Although coefficients have been grouped into pairs in the embodiments described above, other groupings could be used. One possibility would be to use triplets of coefficients, pᵢ, qᵢ, and rᵢ. The third coefficient rᵢ could be found, for example, by generating a second pseudo-random vector and adding it at the location associated with the coefficient pᵢ. Groups of four or more coefficients might also be employed.

Although the embodiments of encoders and decoders described herein employ DCT or DWT transforms, the invention is not limited thereto. Indeed, transforms need not be used at all, and the techniques described can be employed in the pixel domain.

Although the embodiments described above employ watermarking units for all three branches of the image encoder and verification for all three branches of the image decoder, it is believed that acceptable results can be obtained by using only one watermarking unit and one verification unit. If a single watermarking unit and a single verification unit are used, they are preferably placed in the luminance branch. The reason is that this will permit detection of attacks even if a colored image is converted to a grayscale image prior to the attacks.

Instead of being embedded in host coefficients or placed in the header of an encoded image data frame, the signature bits Sᵢ may be stored in a separate file.

Although the embodiments are described above with reference to image files, the invention is also applicable to audio-visual files and other types of files.

This application claims the benefit of priority of U.S. provisional application No. 60/302,184, filed Jun. 29, 2001, the disclosure of which is incorporated herein by reference.

1. A method for watermarking a first file which includes transform coefficients that provide information, comprising the steps of:
(a) selecting groups of coefficients in the first file using a predetermined selection rules;
(b) determining calculated values from the coefficients in each group using a predetermined calculation formula;
(c) combining the calculated values with bias values to generate biased calculated values;
(d) comparing the biased calculated values to a predetermined number to generate signature values for the first file; and
(e) preserving the signature values, for use in detecting whether a second file an authentic version of the first file.

2. The method of claim 1, were in the first file includes image content.

3. The method of claim 1, wherein the transform coefficients are quantized.

4. The method of claim 1, wherein the transform coefficients are DCT coefficients.

5. The method of claim 1, wherein the transform coefficients are DWT coefficients.

6. The method of claim 1, wherein the groups of coefficients selected in step (a) are pairs of coefficients.

7. The method of claim 6, wherein the calculated values are differences between the coefficients in the pairs.

8. The method of claim 1, wherein the bias values are pseudo-random numbers.

9. The method of claim 1, wherein the first file is an image file and the coefficients are coefficients for a luminance component.

10. The method of claim 1, wherein the first file is an image file and the coefficients are coefficients for a chrominance component.

11. A method for watermarking a first file which includes transform coefficients that provide information, and detecting whether a second file is an authentic version of the first file, comprising the steps of:
(a) selecting groups of coefficients in the first file using a predetermined selection rule;
(b) determining first calculated values from the coefficients in each group using a predetermined calculation formula;
(c) combining the first calculated values with bias values to generate first biased calculated values;
(d) comparing the first biased calculated values to a predetermined number to generate signature values for the first file;
(e) selecting groups of coefficients in the second file using the same predetermined selection rule that was employed in step (a);
(f) determining second calculated values from the coefficients in each group selected in step (e) using the same calculation formula that was employed in step (b);
(g) combining the second calculated values with bias values to generate second biased calculated values, the bias values employed in step (g) being the same bias values that were employed in step (c); and
(h) comparing the second biased calculated values with the signature values.

12. The method of claim 11, wherein the first and second files include image content.

13. The method of claim 11, wherein the transform coefficients are quantized.

14. The method of claim 11, were in the transform coefficients are DCT coefficients.

15. The method of claim 11, wherein the transform coefficients are DWT coefficients.

16. The method of claim 11, wherein the groups of coefficients selected in steps (a) and (e) are pairs of coefficients.

17. The method of claim 16, wherein the first and second calculated values are differences between the coefficients in the pairs.

18. The method of claim 11, wherein the first and second files are image files and the coefficients are coefficients for a luminance component.

19. The method of claim 11, wherein the first and second files are image files and coefficients are coefficients for a chrominance component.

20. A method for detecting whether a first file which includes transform coefficients is an authentic version of the second file which includes transform coefficients, the second file being associated with signature values generated by selecting groups of coefficients in the second file using a predetermined selection rule, determining calculated values from the coefficients in each group using a predetermined calculation formula, combining the calculated values with bias values to generate biased calculated values, and comparing the biased calculated values to a predetermined number to generate the signature values for the second file, said method comprising the steps of:
(a) selecting groups of coefficients in the first file using the same predetermined selection rule that was employed to select the groups of coefficients in the second file;
(b) determining calculated values from the coefficients in each group selected in step
(a) using the same calculation formula that was with the second file;
(c) combining the calculated values determined in step (b) with bias values to generate biased calculated values for the first file, the bias values employed in step (c) being the same bias values that were employed with the second file; and
(d) comparing the biased calculated values for the first file with the signature values.

21. The method of claim 20, wherein the first and second files include image content.

22. The method of claim 20, wherein the transform coefficients are quantized.

23. The method of claim 20, were in the transform coefficients are DCT coefficients.

24. The method of claim 20, wherein the transform coefficients are DWT coefficients.

25. The method of claim 20, wherein the groups of coefficients selected in the first and second files are pairs of coefficients.

26. The method of claim 25, wherein the calculated values are differences between the coefficients in the pairs.

27. The method of claim 20, wherein the first and second files are image files and the coefficients are coefficients for a luminance component.

28. The method of claim 20, wherein the first and second files are image files and the coefficients are coefficients for a chrominance component.
